(19) United States
(12) Patent Application Publication
(10) Pub. No.: US 2026/0360727 A1
(43) Pub. Date: Nov. 12, 2026

(54) CATHODE ACTIVE MATERIAL AND BATTERY

(71) Applicant: TOYOTA JIDOSHA KABUSHIKI KAISHA, Toyota-shi (JP)

(72) Inventor: Ryosuke OHSAWA, Okazaki-shi (JP)

(73) Assignee: TOYOTA JIDOSHA KABUSHIKI KAISHA, Toyota-shi (JP)

(21) Appl. No.: 19/561,692

(22) Filed: Mar. 10, 2026

(30) Foreign Application Priority Data
May 12, 2025 (JP) 2025-079936

(51) Int. Cl. H01M 4/525; C01G 53/506; H01M 4/505; H01M 10/052

(52) U.S. Cl. CPC H01M 4/525; C01G 53/506; H01M 4/505; H01M 10/052; C01P 2002/50; C01P 2004/50; C01P 2004/61; C01P 2004/62; C01P 2006/17; C01P 2006/40

(57) ABSTRACT

The present disclosure provides a cathode active material including crystalline primary particles containing Li, a transition metal, and O. The cathode active material is an aggregate including the primary particles. In a pore size distribution obtained by mercury intrusion porosimetry, a peak is present in the range of 20 nm to 300 nm. In a cross section of the cathode active material, R represents the radius of a maximum inscribed circle of the aggregate and D represents a maximum distance from the center of the maximum inscribed circle to an edge of the aggregate, and R and D satisfy 1.10≤D/R≤3.10.

### CROSS-REFERENCE TO RELATED APPLICATION

This application claims priority to Japanese Patent Application No. 2025-079936 filed on May 12, 2025. The disclosure of the above-identified application, including the specification, drawings, and claims, is incorporated by reference herein in its entirety.

### BACKGROUND

### 1. Technical Field

The present disclosure relates to cathode active materials and batteries.

### 2. Description of Related Art

Battery development has been active in recent years. For example, in the automotive industry, batteries for use in battery electric vehicles (BEVs), plug-in hybrid electric vehicles (PHEVs), and hybrid electric vehicles (HEVs) have been actively developed. Active materials containing transition metals such as Ni, Co, and Mn are known as cathode active materials for use in batteries.

For example, Japanese Unexamined Patent Application Publication (Translation of PCT Application) No. 2022-542774 (JP 2022-542774 A) discloses a W-containing high-nickel ternary cathode material represented by the formula LiₐNiₓCo_{y}Mn_{1-x-y}W_{b}M_{c}O₂. This high-nickel ternary cathode material simultaneously includes spherical secondary particles and single-crystal particles. The single-crystal particles basically do not contain W in their interiors, whereas the spherical secondary particles are doped with W.

### SUMMARY

From the standpoint of improving battery performance, reduction in resistance is desired. The present disclosure has been made in view of the above circumstances, and a primary object thereof is to provide a cathode active material with reduced resistance.
(1) A cathode active material including
   primary particles that are crystalline and contain Li, a transition metal, and O, wherein: the cathode active material is an aggregate including the primary particles;
   in a pore size distribution obtained by mercury intrusion porosimetry, a peak is present in a range of 20 nm to 300 nm; and
   in a cross section of the cathode active material, R represents the radius of a maximum inscribed circle of the aggregate and D represents a maximum distance from the center of the maximum inscribed circle to an edge of the aggregate, and R and D satisfy 1.10≤D/R≤3.10.
(2) The cathode active material according to (1), wherein R and D satisfy 1.50≤D/R≤3.10.
(3) The cathode active material according to (1) or (2), wherein the average particle size of the primary particles in the aggregate is 0.5 μm or more.
(4) The cathode active material according to any one of (1) to (3), wherein the primary particles contain, as the transition metal, at least one selected from Ni, Co, and Mn.
(5) A battery including: a cathode active material layer containing a cathode active material; an anode active material layer containing an anode active material; and an electrolyte layer disposed between the cathode active material layer and the anode active material layer, wherein the cathode active material layer contains the cathode active material according to any one of (1) to (4).

The present disclosure can provide a cathode active material with reduced resistance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view illustrating a cathode active material according to the present disclosure;

FIG. 2 is a schematic diagram illustrating the cathode active material according to the present disclosure;

FIG. 3 is a schematic sectional view illustrating a battery according to the present disclosure; and

FIG. 4 is a flowchart illustrating a method for producing a cathode active material according to the present disclosure.

### DETAILED DESCRIPTION OF EMBODIMENTS

Hereinafter, an embodiment will be described with reference to the drawings etc. However, the present disclosure can be implemented in many different forms and is not limited to the embodiments illustrated below. The drawings may schematically illustrate widths, thicknesses, and shapes of components for clarity compared to actual forms. These are merely examples and should not be construed as restrictive.

### A. Cathode Active Material

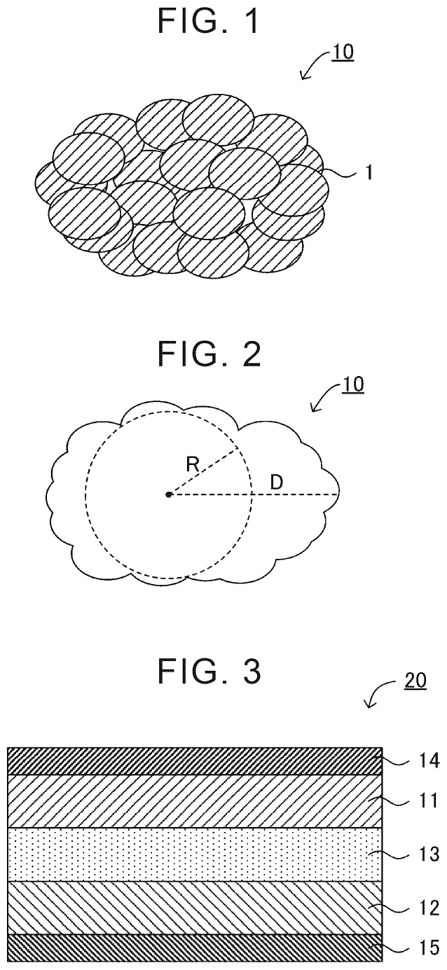

FIG. 1 is a schematic sectional view illustrating a cathode active material according to the present disclosure. FIG. 2 is a schematic diagram illustrating the cathode active material according to the present disclosure. As shown in FIG. 1, a cathode active material 10 includes crystalline primary particles 1 containing Li, TM (TM is a transition metal), and O. The cathode active material 10 is an aggregate formed of the primary particles 1. The aggregate has fine voids therein. Specifically, in a pore size distribution obtained by mercury intrusion porosimetry, a peak is present in the range of 20 nm to 300 nm. As shown in FIG. 2, in a cross section of the cathode active material 10, when the radius of a maximum inscribed circle of the aggregate is defined as R and the maximum distance from the center of the maximum inscribed circle to an edge of the aggregate is defined as D, D/R falls within a predetermined range.

According to the present disclosure, since a peak is present in a predetermined range in the pore size distribution and D/R falls within a predetermined range, a cathode active material with reduced resistance is obtained. That is, the presence of a peak in the predetermined range in the pore size distribution makes it possible to provide an appropriate amount of space within the aggregate. This is presumed to improve ionic conductive properties within the aggregate, thereby reducing resistance. In addition, since D/R falls within the predetermined range, the aggregate has an irregular shape. This is presumed to efficiently secure contact points between the aggregate and an electrically conductive material, improving electronic conductive properties and reducing resistance.

In particular, in the present disclosure, it is preferable that the average particle size of the primary particles constituting the aggregate be large. By forming the aggregate from primary particles having a large particle size (primary particles close to single crystals), cracking, for example, is less likely to occur even after repeated charge and discharge, compared with polycrystalline active materials. When cracking occurs and new surfaces are generated, the new surfaces react with the electrolyte to produce resistive components, leading to an increase in resistance. In contrast, when cracking is suppressed, an increase in resistance can be suppressed. Furthermore, the aggregate can have a smaller specific surface area compared with single-crystal active materials. As a result, accumulation of resistive components due to repeated charge and discharge can be suppressed.

### 1. Primary Particles

The primary particles in the present disclosure are crystalline particles containing Li, TM (TM is a transition metal), and O. Examples of the crystal structure of the primary particles include a layered rock-salt crystal structure and a spinel crystal structure, with a layered rock-salt crystal structure being preferred. The primary particles may have a crystal structure belonging to space group R-3m.

The primary particles contain Li, TM (TM is a transition metal), and O. The primary particles may contain a single transition metal, two transition metals, three transition metals, or four or more transition metals.

Transition metals are metals belonging to Groups 3 to 11 of the periodic table. The transition metal(s) contained in the primary particles may be a metal(s) belonging to the third, fourth, or fifth period. Examples of the transition metal(s) include Ti, V, Cr, Mn, Fe, Co, Ni, Zr, Nb, La, and W.

The primary particles preferably contain at least Ni. This is because a cathode active material with good capacity characteristics can be obtained. When the total amount of transition metals (TM) contained in the primary particles is taken as 1 on a molar basis, the molar fraction of Ni in the primary particles may be, for example, 0.25 or more, 0.33 or more, 0.50 or more, 0.75 or more, 0.80 or more, or 0.90 or more. Increasing the proportion of Ni improves the capacity characteristics.

The primary particles may or may not contain Co. When the total amount of transition metals (TM) contained in the primary particles is taken as 1 on a molar basis, the molar fraction of Co in the primary particles may be, for example, 0 or more, 0.05 or more, or 0.10 or more. The molar fraction of Co in the primary particles may be, for example, 0.40 or less, or 0.20 or less.

The primary particles may or may not contain Mn. When the total amount of transition metals (TM) contained in the primary particles is taken as 1 on a molar basis, the molar fraction of Mn in the primary particles may be, for example, 0 or more, 0.05 or more, or 0.10 or more. The molar fraction of Mn in the primary particles may be, for example, 0.40 or less, or 0.20 or less.

It is preferable that the primary particles contain at least one of the following elements: Ni, Co, and Mn. When the total amount of metals (excluding Li) contained in the primary particles is taken as 1 on a molar basis, the combined molar fraction of Ni, Co, and Mn is, for example, 0.80 or more, and may be 0.90 or more, or may be 0.95 or more. The term “combined molar fraction of Ni, Co, and Mn” also includes cases where the molar fraction of one or two selected from Ni, Co, and Mn is zero.

In addition to Li and TM, the primary particles may further contain another metal M¹ (including a metalloid) other than Li and TM. Examples of the metal M¹ include metals belonging to Groups 12 to 14 of the periodic table. Examples of metals belonging to Groups 12 to 14 include Zn, Al, Si, Ga, Ge, In, and Sn.

The composition of the primary particles is not particularly limited. For example, the primary particles may have a composition represented by the general formula LiₓNiₐCo_{b}Mn_{c}O_{y} (where 0.1≤x≤1.5, 0.5≤a≤1.0, 0≤b≤0.3, 0≤c≤0.3, 0.001≤d≤0.1, 0.001≤e≤0.1, a +b+c+d+e=1.0, and 1.5≤y≤2.1).

### 2. Aggregate

The cathode active material according to the present disclosure is an aggregate formed of a plurality of primary particles. As shown in FIG. 1, the cathode active material 10 is formed of a plurality of primary particles 1. The number of primary particles constituting the aggregate is typically two or more, and may be five or more, or 10 or more. The number of primary particles constituting the aggregate is, for example, 500 or less. The aggregate is, for example, particulate.

As shown in FIG. 2, in a cross section of the cathode active material 10, the radius of a maximum inscribed circle of the aggregate is defined as R, and the maximum distance from the center of the maximum inscribed circle to an edge of the aggregate is defined as D. The “maximum inscribed circle” refers to the inscribed circle having the largest radius. R and D can be determined, for example, from cross-sectional scanning electron microscope (SEM) images using image analysis software such as ImageJ. Typically, R and D satisfy 1.10≤D/R≤3.10. D/R may be 1.50 or more, or may be 2.00 or more. D/R may be 3.00 or less.

The radius R of the maximum inscribed circle is not particularly limited and is, for example, 1 μm or more, and may be 2 μm or more, or 2.5 μm or more. The radius R of the maximum inscribed circle is, for example, 15 μm or less, and may be 12 μm or less, 10 μm or less, or 8 μm or less. The maximum distance D is not particularly limited and is, for example, 2 μm or more, and may be 3 μm or more, or 4 μm or more. The maximum distance D is, for example, 20 μm or less, and may be 15 μm or less, or 12 μm or less.

The average particle size of the primary particles constituting the aggregate is, for example, 0.5 μm or more, and may be 0.6 μm or more, 0.8 μm or more, 1 μm or more, 2 μm or more, or 5 μm or more. The average particle size of the primary particles constituting the aggregate is, for example, 20 μm or less, and may be 15 μm or less, or 10 μm or less. The average particle size of the primary particles can be determined, for example, by SEM cross-sectional observation.

When a pore size distribution of the cathode active material according to the present disclosure is measured by mercury intrusion porosimetry, a peak is typically present in the range of 20 nm to 300 nm. The peak also includes an inflection point. The peak may be present in the range of 20 nm (or 30 nm) to 200 nm (or 160 nm, 100 nm, or 80 nm).

The pore volume at the peak is, for example, 0.010 mL/g or more, and may be 0.015 mL/g or more, 0.020 mL/g or more, 0.025 mL/g or more, or 0.045 mL/g or more. The pore volume at the peak is, for example, 0.100 mL/g or less.

### 3. Cathode Active Material

The cathode active material according to the present disclosure includes crystalline primary particles containing Li, TM (TM is a transition metal), and O. The cathode active material according to the present disclosure is an aggregate formed of a plurality of primary particles. The cathode active material is typically used in batteries. A method for producing the cathode active material is not particularly limited, and examples include the method described below in “D. Method for Producing Cathode Active Material.”

The present disclosure also provides a cathode active material powder. The cathode active material powder includes, as a cathode active material, a plurality of crystalline primary particles containing Li, TM (TM is a transition metal), and O. At least part of the primary particles constitutes an aggregate X. In a pore size distribution of the aggregate X obtained by mercury intrusion porosimetry, a peak is present in the range of 20 nm to 300 nm. When the radius of a maximum inscribed circle of the aggregate X is defined as R and the maximum distance from the center of the maximum inscribed circle to an edge of the aggregate X is defined as D, R and D satisfy 1.1≤D/R≤3.1. Part of primary particles may constitute a single-crystal active material. The proportion of the aggregate X relative to all cathode active materials in the cathode active material powder is, for example, 5 mass % or more, and may be 10 mass % or more, 20 mass % or more, 30 mass % or more, 40 mass % or more, 50 mass % or more, 60 mass % or more, or 70 mass % or more.

### B. Cathode Composition

The present disclosure also provides a cathode composition containing the cathode active material described above.

According to the present disclosure, a cathode composition with reduced resistance can be obtained using the cathode active material described above. The cathode composition may further contain other materials (e.g., an electrically conductive material and a binder) in addition to the cathode active material. The cathode composition may contain the cathode active material powder described above. The cathode composition may be in the form of powder or in the form of a slurry containing a dispersion medium.

The proportion of the cathode active material in the solid content of the cathode composition is, for example, 20 mass % or more, and may be 30 mass % or more, or 40 mass % or more. If the proportion of the cathode active material is too low, sufficient energy density may not be obtained. The proportion of the cathode active material in the solid content of the cathode composition is, for example, 95 mass % or less, and may be 70 mass % or less, or 60 mass % or less. If the proportion of the cathode active material is too high, ionic conductive properties and electronic conductive properties may relatively decrease.

The cathode composition may contain an electrically conductive material. Addition of an electrically conductive material improves electronic conductive properties. Examples of electrically conductive materials include carbon-based electrically conductive materials, metal particles, and electrically conductive polymers. Examples of carbon-based electrically conductive materials include particulate materials such as acetylene black (AB) and Ketjenblack (KB), and fibrous materials such as vapor-grown carbon fibers (VGCF), carbon nanotubes (CNTs), and carbon nanofibers (CNFs).

The cathode composition may contain a binder. Addition of a binder makes it possible to obtain a cathode active material layer in which the cathode active material is less likely to detach. Examples of binders include rubber-based binders such as styrene-butadiene rubber (SBR) and butadiene rubber (BR), polycarboxylic-acid-based binders such as carboxymethyl cellulose, and fluoride-based binders such as polyvinylidene fluoride (PVdF).

### C. Battery

FIG. 3 is a schematic sectional view illustrating a battery according to the present disclosure. As shown in FIG. 3, a battery 20 includes a cathode active material layer 11, an anode active material layer 12, an electrolyte layer 13 disposed between the cathode active material layer 11 and the anode active material layer 12, a cathode current collector 14 that collects current from the cathode active material layer 11, and an anode current collector 15 that collects current from the anode active material layer 12. In the present disclosure, the cathode active material layer 11 contains the cathode active material described above in “A. Cathode Active Material” or the cathode composition described above in “B. Cathode Composition.”

According to the present disclosure, a battery with reduced resistance can be obtained by using the cathode active material or the cathode composition described above.

### 1. Cathode Active Material Layer

The cathode active material layer contains at least a cathode active material. The cathode active material layer may also contain an electrically conductive material and a binder. The cathode active material, the electrically conductive material, and the binder are the same as those described above in “A. Cathode Active Material” and “B. Cathode Composition.”

The cathode active material layer may contain an electrolyte. The electrolyte is, for example, an electrolyte solution described later. Alternatively, the cathode active material layer may contain a solid electrolyte. The thickness of the cathode active material layer is, for example, 0.1 μm or more and 1000 μm or less, and may be 1 μm or more and 500 μm or less, or 30 μm or more and 100 μm or less.

### 2. Anode Active Material Layer

The anode active material layer contains at least an anode active material. Examples of anode active materials include carbon-based active materials, Li-based active materials, Si-based active materials, and oxide-based active materials.

Examples of carbon-based active materials include graphite, soft carbon, and hard carbon. The graphite may be either natural graphite or artificial graphite. Examples of Li-based active materials include Li and Li alloys. Examples of Li alloys include Li—Si alloys. Examples of Si-based active materials include Si, SiC composite active materials, Si alloys, and Si oxides. Examples of SiC composite active materials include active materials in which Si or an Si alloy is supported on a carbon support. Examples of oxide-based active materials include lithium titanate such as Li₄Ti₅O₁₂.

The anode active material layer may contain at least one of the following components: an electrically conductive material, a binder, and an electrolyte. Details of the electrically conductive material, the binder, and the electrolyte are the same as those described above in “1. Cathode Active Material Layer.” The thickness of the anode active material layer is, for example, 0.1 μm or more and 1000 μm or less, and may be 1 μm or more and 500 μm or less, or 30 μm or more and 100 μm or less.

### 3. Electrolyte Layer

The electrolyte layer is a layer disposed between the cathode active material layer and the anode active material layer, and contains at least an electrolyte. The electrolyte is, for example, a liquid electrolyte (electrolyte solution).

An example of the electrolyte solution is a non-aqueous electrolyte solution. The non-aqueous electrolyte solution contains, for example, a lithium salt and a non-aqueous solvent. Examples of lithium salts include inorganic lithium salts such as LiPF₆, LiBF₄, LiClO₄, and LiAsF₆, and organic lithium salts such as LiCF₃SO₃, LiN(SO₂CF₃)₂, LiN(SO₂C₂F₅)₂, and LiC(SO₂CF₃)₃.

Examples of non-aqueous solvents include carbonate-based solvents such as ethylene carbonate (EC), propylene carbonate (PC), butylene carbonate (BC), dimethyl carbonate (DMC), diethyl carbonate (DEC), and ethyl methyl carbonate (EMC). The non-aqueous electrolyte solution may contain an ionic liquid. Another example of the electrolyte solution is an aqueous electrolyte solution. The electrolyte layer may include a separator impregnated with the electrolyte solution described above.

### 4. Battery

The battery according to the present disclosure preferably includes a cathode current collector that collects current from the cathode active material layer, and an anode current collector that collects current from the anode active material layer.

The type of battery according to the present disclosure is not particularly limited, but is typically a lithium-ion battery. The battery may be a primary battery or a secondary battery, with a secondary battery being preferred. This is because a secondary battery can be repeatedly charged and discharged and is useful as, for example, an in-vehicle battery. Applications of the battery include power sources for vehicles such as hybrid electric vehicles (HEVs), plug-in hybrid electric vehicles (PHEVs), battery electric vehicles (BEVs), gasoline vehicles, and diesel vehicles. In particular, the battery is preferably used as a traction power source for hybrid electric vehicles (HEVs), plug-in hybrid electric vehicles (PHEVs), or battery electric vehicles (BEVs). The battery may also be used as a power source for mobile bodies other than vehicles (e.g., trains, ships, and aircraft) or as a power source for electrical products such as information processing devices.

### D. Method for Producing Cathode Active Material

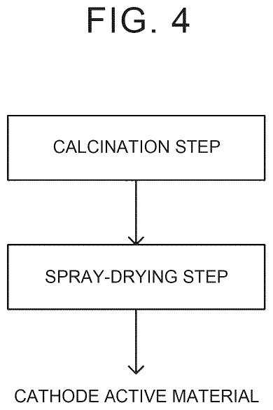

The present disclosure also provides a method for producing the cathode active material described above. As shown in FIG. 4, the method preferably includes a calcination step of calcining a mixture containing a TM-containing transition metal hydroxide and an Li source to obtain a calcined product, and a spray-drying step of forming a cathode active material, which is a granulated body of the calcined product, by spray drying using the calcined product.

According to the present disclosure, a cathode active material with reduced resistance can be obtained by performing the calcination step and the spray-drying step.

### 1. Calcination Step

The calcination step is a step of calcining a mixture containing a TM-containing transition metal hydroxide and an Li source to obtain a calcined product.

The transition metal hydroxide contains TM (TM is a transition metal). The transition metal hydroxide corresponds to a precursor of the cathode active material.

The method for synthesizing the transition metal hydroxide is not particularly limited, and examples include the following method. For example, an aqueous raw material solution of the transition metal hydroxide is first prepared. The aqueous raw material solution may be prepared, for example, by dissolving a water-soluble transition metal compound in water. Examples of transition metal compounds include metal salts such as sulfates and nitrates. Examples of Ni sources include NiSO₄ and Ni(NO₃)₂. Examples of Co sources include CoSO₄, Co(NO₃)₂, and Co(NO₃)₃. Examples of Mn sources include MnSO₄ and Mn(NO₃)₂. The composition of the aqueous raw material solution is adjusted as appropriate according to the target cathode active material.

Next, an aqueous sodium hydroxide solution is added to a reaction vessel, and while maintaining the pH in an alkaline range (e.g., pH 11.3 to pH 12.0), the aqueous raw material solution and an aqueous NH₃ solution are added dropwise into the reaction vessel. The reaction temperature is not particularly limited and is, for example, 50 °C or more and 65 °C or less. After completion of the reaction, the transition metal hydroxide is preferably collected by filtration, washed with water, and then dried.

In the calcination step, a mixture containing the transition metal hydroxide and an Li source is prepared. Examples of Li sources include lithium hydroxide, lithium carbonate, lithium nitrate, lithium acetate, lithium oxide, and lithium chloride. The Li source may be lithium hydroxide, or may be an Li-containing compound other than lithium hydroxide. The molar ratio of Li contained in the Li source to TM contained in the transition metal hydroxide is, for example, 0.8 or more and 1.2 or less, and may be 0.9 or more and 1.1 or less, or may be 1.0.

The mixture preferably contains a molten salt. When the molten salt functions as a flux, sufficient grain growth of the primary particles can be achieved. The molten salt may contain Li. An example of the molten salt is lithium hydroxide. The molar ratio of Li contained in the molten salt to TM contained in the transition metal hydroxide (Li/TM) is, for example, 0.1 or more and 1.0 or less. Li/TM may be 0.15 or more, 0.2 or more, or 0.25 or more. Li/TM may be 0.8 or less.

In the calcination step, the mixture is calcined to obtain a calcined product. The calcination temperature is, for example, 600 °C or more and 1000 °C or less, and may be 700 °C or more and 900 °C or less. The calcination time is not particularly limited, and is, for example, five hours or more and 15 hours or less, and may be eight hours or more and 12 hours or less. The atmosphere in the calcination step typically contains oxygen. Examples of the calcination method used in the calcination step include methods employing a calcination furnace such as a muffle furnace or an electric furnace.

In the calcination step, the calcined product may be subjected to a water-washing treatment. The calcined product may also be subjected to a pulverization treatment. Examples of pulverization methods include jet milling, hammer milling, laboratory milling, and ball milling.

### 2. Spray-Drying Step

The spray-drying step is a step of forming a cathode active material, which is a granulated body of the calcined product, by spray drying using the calcined product. Examples include spray drying. In spray drying, for example, a pulverized calcined product is dispersed in water, and the resulting dispersion is sprayed using a spray-drying apparatus.

The inlet air temperature is not particularly limited and is, for example, 150 °C or more and 350 °C or less. The inlet air pressure is, for example, 1.0 MPa or more and 3.0 MPa or less. The nozzle pressure of the spray nozzle is, for example, 0.2 MPa or more and 1.0 MPa or less.

### 3. Cathode Active Material

The cathode active material obtained through the above steps is the same as that described above in “A. Cathode Active Material.”

The present disclosure is not limited to the embodiment described above. The above embodiment is merely illustrative, and any structure that has substantially the same configuration as, and exhibits functions and effects similar to, the technical idea described in the claims of the present disclosure is included within the technical scope of the present disclosure.

### Comparative Example 1

### Preparation of Cathode Active Material

NiSO₄, CoSO₄, and MnSO₄ were prepared as raw materials, and these materials were dissolved in deionized water to prepare an aqueous raw material solution. The molar ratio of Ni, Co, and Mn in the aqueous raw material solution was Ni:Co:Mn=8:1:1. The concentration of the aqueous raw material solution (the proportion of the total amount of raw materials relative to the aqueous raw material solution) was 30 mass %.

Thereafter, a predetermined amount of aqueous NH₃ solution was placed in a reaction vessel, and while stirring the solution with a stirrer, the atmosphere inside the reaction vessel was purged with nitrogen. An aqueous NaOH solution was then added to the reaction vessel, and while maintaining the pH at an alkaline level (pH=12) and keeping the temperature constant, the aqueous raw material solution and the aqueous NH₃ solution were added dropwise into the reaction vessel to precipitate a transition metal hydroxide. The reaction temperature was 60 °C, and the reaction time was 10 hours. The precipitated transition metal hydroxide was then collected by filtration, and washed with deionized water by dispersion using a spoon. The washed transition metal hydroxide was dried at 120 °C for 16 hours to obtain a transition metal hydroxide as a precursor.

An Li source (LiOH) was then added to the obtained precursor and mixed in an agate mortar to obtain a first mixture. The amount of the Li source added was adjusted such that the molar ratio of Li in the Li source to the total amount of Ni, Co, and Mn (NCM) contained in the precursor (Li/NCM) was 1.1. The obtained first mixture was calcined in a calcination furnace at 900 °C for 10 hours in an oxygen atmosphere to obtain a calcined product. The calcined product was then deagglomerated using a jet mill to adjust the particle size. A cathode active material was thus obtained.

### Fabrication of Battery

A battery was fabricated using the obtained cathode active material. Specifically, a cathode composition paste containing the cathode active material, an electrically conductive material (acetylene black), and a binder (polyvinylidene fluoride) at a mass ratio of cathode active material:electrically conductive material:binder=88:10:2 was applied onto the surface of a metal foil that would serve as a cathode current collector, using a film applicator with a thickness adjustment function (manufactured by Allgood Co., Ltd.). The coated metal foil was then dried at 80 °C for five minutes in a dryer to obtain a cathode including a cathode current collector and a cathode active material layer.

Next, an anode composition paste containing an anode active material (natural graphite) and binders (SBR and CMC) was applied onto the surface of a metal foil that would serve as an anode current collector, using a film applicator with a thickness adjustment function (manufactured by Allgood Co., Ltd.). The coated metal foil was then dried at 80 °C for five minutes in a dryer to obtain an anode including an anode current collector and an anode active material layer. A 1 M LiPF₆ solution was prepared as an electrolyte solution. A mixed solvent of ethylene carbonate (EC), dimethyl carbonate (DMC), and ethyl methyl carbonate (EMC) mixed at a volume ratio of EC:DMC:EMC=3:4:3 was used as a solvent for the electrolyte solution. A wound cylindrical battery was obtained using the cathode, anode, and electrolyte solution described above.

### Example 1

A precursor was prepared in the same manner as in Comparative Example 1. An Li source (LiOH) was added to the obtained precursor and mixed in an agate mortar to obtain a mixture. The amount of the Li source added was adjusted such that the molar ratio of Li in the Li source to the total amount of Ni, Co, and Mn (NCM) in the precursor (Li/NCM) was 2.0. The obtained mixture was calcined in a calcination furnace at 800 °C for 10 hours in an oxygen atmosphere to obtain a calcined product.

The obtained calcined product was deagglomerated in a mortar. While 100 mL of deionized water in a beaker was stirred with a stirrer, 30 g of the deagglomerated calcined product was added and stirred for five minutes (water washing). Excess Li was removed by the water washing, thereby bringing the calcined product closer to the target stoichiometry. The solid content was then collected by suction filtration and dried at 80 °C for 12 hours. The dried calcined product was subsequently deagglomerated using a jet mill to adjust the particle size.

Subsequently, 100 mL of deionized water was placed in a beaker, and 30 g of the calcined product with the adjusted particle size was added. The resulting slurry was spray-dried in a Buchi spray dryer at an inlet air temperature of 270 °C, an inlet air pressure of 2.0 MPa, and a spray-nozzle pressure of 0.4 MPa+0.1 MPa, thereby obtaining a cathode active material. A battery was fabricated in the same manner as in Comparative Example 1, except that the obtained cathode active material was used.

### Example 2

A cathode active material and a battery were obtained in the same manner as in Example 1, except that the spray-drying conditions were changed to an inlet air temperature of 300 °C, an inlet air pressure of 2.0 MPa, and a spray-nozzle pressure of 0.6 MPa±0.1 MPa.

### Example 3

A cathode active material and a battery were obtained in the same manner as in Example 1, except that the spray-drying conditions were changed to an inlet air temperature of 310 °C, an inlet air pressure of 2.0 MPa, and a spray-nozzle pressure of 0.6 MPa±0.1 MPa.

### Comparative Example 2

A cathode active material and a battery were obtained in the same manner as in Example 1, except that the spray-drying conditions were changed to an inlet air temperature of 330 °C, an inlet air pressure of 2.0 MPa, and a spray-nozzle pressure of 0.6 MPa±0.1 MPa.

### Evaluation

### XRD Measurement

X-ray diffraction (XRD) measurements using CuKα radiation were performed on the cathode active materials obtained in Examples 1 to 3 and Comparative Examples 1 and 2. As a result, all of the cathode active materials obtained in Examples 1 to 3 and Comparative Examples 1 and 2 were confirmed to have a layered rock-salt crystal phase belonging to space group R-3m.

### Pore Size Distribution Measurement

Mercury intrusion porosimetry was performed on the cathode active materials obtained in Examples 1 to 3 and Comparative Example 2 to measure the pore size distribution. Specifically, the pore size distribution of the cathode active material was measured by introducing mercury into a sealed sample tube containing 1 g of the cathode active material using a mercury intrusion porosimeter manufactured by Micromeritics Instrument Corporation. The results are shown in Table 1.

### Cross-Sectional Observation

Cross sections of the cathode active material layers of the batteries obtained in Examples 1 to 3 and Comparative Examples 1 and 2 were observed by a scanning electron microscope (SEM), and the radius R of the maximum inscribed circle of the aggregate and the maximum distance D from the center of the maximum inscribed circle to an edge of the aggregate were determined using image analysis. The results are shown in Table 1.

### Initial Resistance

Initial resistance was measured using the batteries obtained in Examples 1 to 3 and Comparative Examples 1 and 2. Specifically, each of the batteries was charged to 4.3 V and then discharged to 3.7 V. Subsequently, each of the batteries was discharged at 25 °C for 10 seconds at 0.1 C, 0.3 C, 0.5 C, 0.7 C, and 1.0 C, and the voltage drop (V) was measured. The relationship between current and voltage drop (V) was plotted, and the slope of the straight line obtained by linear approximation was defined as the resistance (I-V resistance). The results are shown in Table 1. The initial resistance values in Table 1 are relative values, with the initial resistance of Comparative Example 1 taken as 100%.

TABLE 1

| | | | | | Peak | | | | Initial |
|---|---|---|---|---|---|---|---|---|---|
| | Ratio | | | | Position | R | D | | Resistance |
| | Li | Ni | Co | Mn | (nm) | (μm) | (μm) | D/R | (%) |
| Comparative | 1.1 | 0.8 | 0.1 | 0.1 | — | 6 | 6.5 | 1.08 | 100 |
| Example 1 | | | | | | | | | |
| Example 1 | 2.0 | 0.8 | 0.1 | 0.1 | 89 | 6 | 6.7 | 1.12 | 76 |
| Example 2 | 2.0 | 0.8 | 0.1 | 0.1 | 58 | 3 | 5 | 1.67 | 74 |
| Example 3 | 2.0 | 0.8 | 0.1 | 0.1 | 33 | 2.7 | 8 | 2.96 | 73 |
| Comparative | 2.0 | 0.8 | 0.1 | 0.1 | 15 | 2.8 | 9 | 3.21 | 101 |
| Example 2 | | | | | | | | | |

As shown in Table 1, Examples 1 to 3 exhibited lower initial resistance than Comparative Examples 1 and 2. This is presumably because the presence of a peak within a predetermined range in the pore size distribution provides an appropriate amount of space within the aggregates, improving ionic conductive properties, and because D/R falling within a predetermined range efficiently ensures contact points with the electrically conductive material, improving electronic conductive properties.

What is claimed is:

1. A cathode active material comprising primary particles that are crystalline and contain Li, a transition metal, and O, wherein:
the cathode active material is an aggregate including the primary particles;
in a pore size distribution obtained by mercury intrusion porosimetry, a peak is present in a range of 20 nm to 300 nm; and
in a cross section of the cathode active material, R represents a radius of a maximum inscribed circle of the aggregate and D represents a maximum distance from a center of the maximum inscribed circle to an edge of the aggregate, and
R and D satisfy 1.10≤D/R≤3.10.

2. The cathode active material according to claim 1, wherein R and D satisfy 1.50≤D/R≤3.10.

3. The cathode active material according to claim 1, wherein an average particle size of the primary particles in the aggregate is 0.5 μm or more.

4. The cathode active material according to claim 1, wherein the primary particles contain, as the transition metal, at least one selected from Ni, Co, and Mn.

5. A battery comprising:
a cathode active material layer containing a cathode active material;
an anode active material layer containing an anode active material; and
an electrolyte layer disposed between the cathode active material layer and the anode active material layer, wherein
the cathode active material layer contains the cathode active material according to claim 1.
